(19) United States
(12) Patent Application Publication
(10) Pub. No.: US 2013/0206685 A1
(43) Pub. Date: Aug. 15, 2013

(54) METHOD FOR FIXING CARBON DIOXIDE AND COMPOSITION THEREFOR

(71) Applicant: Industry Foundation of Chonnam National University, (US)

(72) Inventors: Yul ROH, Gwangju (KR); Sur Ku KANG, Gwangju (KR)

(73) Assignee: INDUSTRY FOUNDATION OF CHONNAM NATIONAL UNIVERSITY, Gwangju-si (KR)

(21) Appl. No.: 13/660,587

(22) Filed: Oct. 25, 2012

(30) Foreign Application Priority Data
Feb. 14, 2012 (KR) 10-2012-0015023

(51) Int. Cl. C02F 3/32

(52) U.S. Cl. CPC C02F 3/322
USPC 210/610; 435/253.6

(57) ABSTRACT

Provided is a method for biologically fixing carbon dioxide dissolved in contaminated water using a microorganism derived from rhodolith. The method includes enrichment-incubating a microorganism derived from rhodolith, and treating and reacting the enrichment-incubated microorganism in contaminated water to fix carbon dioxide dissolved in contaminated water as a carbonate mineral. The method for biologically fixing carbon dioxide has a simple fixing process and is environmentally friendly, compared with chemical carbon dioxide fixing technology. In addition, this method enables fast fixation of carbon dioxide even at room temperature, and thus can be easily applied in the industrial field, and is also useful in an aspect of resource recycling since the carbon dioxide is eventually fixed in the form of calcium carbonate.

### CROSS-REFERENCES TO RELATED APPLICATION

This patent application claims the benefit of priority from Korean Patent Application No. 10-2012-0015023, filed on Feb. 14, 2012 in the Korean Intellectual Property Office (KIPO), the entire of which are incorporated herein by reference.

### BACKGROUND OF THE INVENTION

1. Field of the Invention

The present invention relates to methods for fixing carbon dioxide and compositions therefor, more specifically, to a method for biologically fixing carbon dioxide dissolved in water, especially contaminated water, using a microorganism derived from rhodolith and a composition therefor.

2. Description of the Related Art

Currently, fossil fuels, the most widely used energy source as they have high energy efficiency, are easy to store, and their infrastructure is well established as well as they are especially advantageous in an aspect of price competitiveness, and thus, will be used as an important energy source in the future as well. However, a large amount of greenhouse gases discharged to the atmosphere thanks to the reckless use of such fossil fuels are causing environmental problems, such as global warming and ecosystem disturbance. In order to solve these problems, worldwide collaboration for carbon fixation is required, and as a result, agreement on the Kyoto Protocol was concluded in December of 1997, evoking a feeling of sympathy that generation of greenhouse gases should be decreased among countries. The essence of the agreement was to reduce emission of six kinds of greenhouse gases including carbon dioxide (carbon dioxide, methane, nitrous oxide, perfluorocarbon, hydrofluorocarbon and sulfur hexafluoride), and was executed so as to effectively reduce greenhouse gas emission based on economic principles, which define the sequential applications in consideration of gaps between countries and tradable emission permits. Based on the emission of carbon dioxide as of 1990, developed countries have aimed to reduce emission of carbon dioxide by 5.2% by 2012.

In particular, the highest amount of carbon dioxide has been emitted among greenhouse gases, and has recently increased quite rapidly to reach 384 ppm in 2007. Since 2000, carbon dioxide emission has been increasing by an average of approximately 2 ppm per year. For reduction of such carbon dioxide emission, developments of technology for CO₂ capture and storage (CCS) have become a worldwide issue. CCS technology consists of (1) separating and capturing carbon dioxide from major carbon dioxide generating places, such as thermal power plants, (2) transporting the captured carbon dioxide, (3) burying and storing the carbon dioxide underground using a geological method, (4) storing the carbon dioxide at sea in a stable form, (5) converting the carbon dioxide into carbonate minerals (mineral carbonation) and (6) converting the carbon dioxide into various carbon-containing chemicals such as alcohol. Since carbonate mineral is in the most thermodynamically stable state among carbon-containing materials, mineral carbonation is evaluated as the most attractive technology among the six CCS technologies, for fixing carbon dioxide caused by artificial industrial activities, and active research has been conducted, especially in developed counties.

Although mineral carbonation of carbon dioxide is very stable, the reaction rate is quite slow. Thus, active research has been conducted to increase such a reaction rate. However, mineral carbonation technology, which is inexpensive and highly efficient enough to be applied in the industrial field, remains to be developed.

### SUMMARY OF THE INVENTION

Accordingly, an aspect of the present invention is to provide an efficient method for fixing carbon dioxide which has an increased reaction rate and a composition therefor.

To solve the problems, one aspect of the present invention provides a method for fixing carbon dioxide dissolved in water, especially contaminated water. The method includes enrichment-incubating a microorganism derived from rhodolith, and treating and reacting the enrichment-cultured microorganism in contaminated water to fix carbon dioxide dissolved in contaminated water as a carbonate mineral.

Another aspect of the present invention provides a composition for fixing carbon dioxide dissolved in contaminated water, which includes an enrichment culture broth of microorganisms derived from rhodolith as an active ingredient to fix carbon dioxide dissolved in contaminated water as a carbonate mineral.

### BRIEF DESCRIPTION OF THE DRAWINGS

FIG. 1 is an image of rhodolith taken from the shore of Seogwang-ri, Udo, Bukjeju-gun, Jeju Island.

FIG. 2 is a graph showing X-ray diffraction (XRD) results of the rhodolith taken from the shore of Seogwang-ri, Udo, Bukjeju-gun, Jeju Island.

FIG. 3 is an image showing a process for enrichment-incubating a microorganism derived from rhodolith, and the results of enrichment incubation.

FIG. 4 is a phylogenetic analysis diagram showing the 16S rRNA-DGGE analysis results of microorganisms existing in an enrichment culture broth of a microorganism derived from rhodolith.

FIG. 5 is a graph showing the XRD analysis results of a carbonate mineral generated by enrichment incubation of a microorganism derived from rhodolith.

FIG. 6 is a diagram and graph showing the SEM-EDS analysis results of a carbonate mineral generated by enrichment incubation of a microorganism derived from rhodolith.

### DESCRIPTION OF THE PREFERRED EMBODIMENTS

Hereinafter, the present invention will be described in further detail.

1. Method for Fixing Carbon Dioxide

One aspect of the present invention provides a method for fixing carbon dioxide dissolved in contaminated water. Here, the method includes enrichment-incubating a microorganism derived from rhodolith, and fixing carbon dioxide dissolved in contaminated water as carbonate mineral by treating and reacting the enrichment-cultured microorganism in contaminated water.

The method for fixing carbon dioxide dissolved in contaminated water according to the present invention includes 1) enrichment-incubating a microorganism derived from rhodolith, and 2) treating and reacting the enrichment-cultured microorganism in Step (1) in contaminated water to fix carbon dioxide dissolved in contaminated water as a carbonate mineral.

The enrichment incubation of the rhodolith-derived microorganism in Step (1) is performed by a incubation method including 1′) collecting rhodolith, and 2′) putting the rhodolith collected in Step (1′) into at least one medium selected from the group consisting of a D-1 medium (Sanchez-Roman et al., 2009 and Sanchez-Roman et al., 2011), a Mueller-Hinton (MH) medium (Rodroguez-Valera et al., 1981), and a saline medium (Chahal et al., 2011), and incubating the rhodolith under an aerobic condition. The compositions of the media are summarized in Table 1 below.

TABLE 1

| Composition | | | | | |
|---|---|---|---|---|---|
| of D-1 medium | | Composition | | Composition of saline | |
| Compo- | | of MH medium | | medium | |
| nent | Content | Component | Content | Component | Content |
| Yeast | 1.0% | Yeast extract | 1.0% | Nutrient | 3 g/L |
| extract | | | | broth | |
| Proteose | 0.5% | Proteose | 0.5% | NH₄Cl | 10 g/L |
| peptone | | peptone | | | |
| Glucose | 0.1% | Glucose | 0.1% | NaHCO₃ | 2.12 g/L |
| NaCl | 3.5% | NaCl | 2.5-20% | NaCl | 0.85% |
| | | | | CaCl₂•H₂O | 25 g/L |

The rhodolith in Step 1′) is an aggregate of authigenic minerals formed by precipitation of calcium carbonate, which is a main component of calcite, by red algae that grows with precipitation of calcite that is a carbonate mineral within cell or between cell walls. That is, rhodolith denotes a nodule formed by precipitation of calcium carbonate by red algae. The calcium carbonate which constitutes rhodolith is precipitated by biological metabolism of red algae. In this case, the calcium carbonate is derived from a carbonate mineral such as calcite existing around red algae. Carbonate mineral may be generated for various reasons, one of which is a metabolism of a carbonate mineral-forming microorganism, and thus the carbonate mineral-forming microorganism may also exist in rhodolith. Accordingly, the rhodolith used in Step 1′) is a source for the carbonate mineral-forming microorganism.

The rhodolith of Step 1′) includes the carbonate mineral-forming microorganism. The carbonate mineral-forming microorganism includes all of various microorganisms which grow in rhodolith to contribute to the formation of a carbonate mineral, including Proteus mirabilis and Marinobacterium coralli, which combines carbon dioxide or carbonate ions dissolved in water with metal cations during a metabolic pathway to form the carbonate mineral. The rhodolith of Step 1′) preferably having a size of 3 cm to 10 cm, more preferably 5 cm to 7 cm, is collected, but the present invention is not limited thereto. When the size of the rhodolith is less than 3 cm, the absolute number of carbonate-forming microorganisms may be problematic, whereas, when the size of the rhodolith is more than 10 cm, the number of carbonate mineral-forming microorganisms per unit square of the rhodolith, i.e. the density of carbonate mineral-forming microorganisms, is decreased, thus causing an increase in the time required for enrichment incubation of a microorganism in Step 2′). In a specific embodiment of the present invention, rhodolith having a size of 5 cm to 7 cm collected from the shore of Seogwang-ri, Udo, Bukjeju-gun, Jeju Island, is used for enrichment incubation of a carbonate mineral-forming microorganism.

Media used in Step 2′) may be used without limitation as long as they can be used for enrichment incubation of the carbonate-forming microorganism, and examples of the media used herein include a D-1 medium, an MH medium and a saline medium. Since the media contain a yeast extract and proteose-peptone or a nutrient broth which is required for the growth of carbonate-forming microorganisms, the media are appropriate for the growth of microorganisms, and are also appropriate for the growth of microorganisms growing in the sea since the media contain NaCl.

To the medium used in Step 2′), calcium cations or magnesium cations are preferably added. In order to enrichment-incubate the microorganisms involved in generation of the carbonate mineral among the microorganisms existing in rhodolith, calcium cations or magnesium cations, which the microorganisms use to fix CO₃²⁻ as a carbonate mineral during a biological metabolic pathway, may be added to the medium. The addition of the calcium cations or magnesium cations is preferably addition of calcium salt or magnesium salt, more preferably addition of at least one selected from the group consisting of calcium acetate, magnesium acetate, and a mixture of calcium acetate and magnesium acetate, but the present invention is not limited thereto. Further, when the mixture of calcium acetate and magnesium acetate is added, the ratio between calcium acetate and magnesium acetate is preferably 1:1 to 1:10, more preferably 1:1 to 1:7, and most preferably 1:1 to 1:5, but the present invention is not limited thereto.

The incubation in Step 2′) is performed under an aerobic condition similar to the marine environments in which rhodolith exists. The rhodolith from Udo, Jeju Island used in the specific embodiment of the present invention has been mainly formed and exists in the shallow marine environments in Udo. It has been reported that rhodolith is formed by red algae. However, there is no report on a mechanism of forming a material serving as a core for forming rhodolith. Accordingly, the present inventors have addressed that microorganisms existing in rhodolith can form calcium carbonate which can function as an initial core during formation of rhodolith. Thus, the microorganisms in rhodolith are enrichment-incubated under an aerobic condition similar to the environment of a region in which rhodolith can be formed.

In the specific embodiment of the present invention, the rhodolith collected from the shore of Seogwang-ri, Udo, Bukjeju-gun, Jeju Island is pulverized using an agate and mortar, and 5 g of the pulverized rhodolith is then put into a D-1 medium, and after injecting a mixture of calcium acetate and magnesium acetate, the resulting mixture is incubated under an aerobic condition for 7 days to obtain an enrichment culture broth of microorganisms derived from the rhodolith.

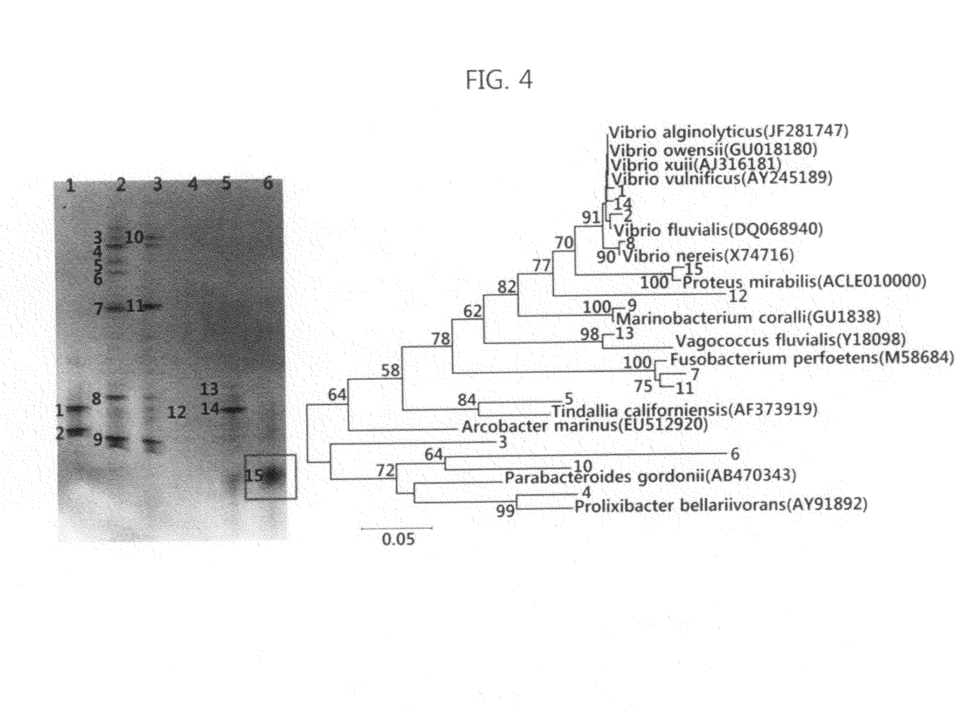

The enrichment-cultured microorganism in Step 2) may include at least one microorganism selected from the group consisting of Vibrio alginolyticus, Vibrio owensii, Vibrio xuii, Vibrio vulnificus, Vibrio fluvialis, Vibrio nereis, Proteus mirabilis, Marinobacterium coralli, Vagococcus fluvialis, Fusobacterium perfoetens, Tindallia californiensis, Arcobacter marinus, Parabacteroides gordonii, and Prolixibacter bellariivorans, and more preferably, at least one microorganism selected from the group consisting of Vibrio alginolyticus, Vibrio owensii, Vibrio xuii, Vibrio vulnificus, Vibrio fluvialis, Vibrio nereis, Proteus mirabilis, and Marinobacterium coralli, but the present invention is not limited thereto. In the specific embodiment of the present invention, the 16S rRNA-DGGE analysis is carried out to confirm the diversity of iron-reducing microorganisms existing in the enrichment culture broth of the microorganisms derived from the rhodolith. As a result, the presence of various microorganism species, including Proteus mirabilis and Marinobacterium coralli, were confirmed (see FIG. 4).

The contaminated water in Step 2) refers to water in which an excessive amount of carbon dioxide gas generated from artificial industrial activities is dissolved, that is, sea water or fresh water in which carbon dioxide to be fixed is dissolved. The carbon dioxide to be fixed may be dissolved and exist in the form of carbonate anions (CO₃²⁻) or hydrogen carbonate anions (HCO₃⁻) in sea water or fresh water. In addition to the carbon dioxide, metal cations may exist in contaminated water. The metal may be Group 1 or Group 2 metals, preferably Group 2 metals, and most preferably calcium or magnesium, but the present invention is not limited thereto. The carbonate anions or hydrogen carbonate anions are combined with calcium or magnesium cations existing in the contaminated water so that the carbonate anions or hydrogen carbonate anions are fixed in the form of a carbonate mineral. In this specification, the combination of the cations and the anions may be facilitated by biological metabolism of the rhodolith-derived microorganisms.

The treatment in Step 2) is performed by injecting the enrichment-cultured rhodolith-derived microorganism in Step 1) into the contaminated water. Here, an enrichment culture broth of the rhodolith-derived microorganisms may be injected in a density of 0.5 w/v % to 1.5 w/v % of the total volume of the contaminated water. When the enrichment culture broth is injected at a density of less than 0.5 w/v % of the total volume of the contaminated water, a great deal of time is required to fix carbon dioxide dissolved in the contaminated water. When the enrichment culture broth is injected at a density of more than 1.5 w/v % of the total volume of the contaminated water, the concentration of dissolved oxygen decreases thanks to the excessive respiration of microorganisms in the enrichment culture broth, and thus the contaminated water forms an anaerobic environment, and may eventually go stale. Accordingly, since it is important to properly regulate the amount of the microorganisms treated in the contaminated water, the treatment should be performed by properly regulating the density of the enrichment culture broth.

The treatment in Step 2) may be performed together with additional injection of calcium cations or magnesium cations along with the enrichment culture broth in Step 1) into the contaminated water. In particular, when the concentration of the calcium cations or magnesium cations in the contaminated water is low, the carbonate anions or hydrogen carbonate anions in the contaminated water are not easily fixed as a carbonate mineral. In this case, the calcium cations or magnesium cations may be supplied to facilitate such fixation. The supply of the calcium cations or magnesium cations is preferably performed by treatment of calcium salt or magnesium salt, and more preferably, by treatment of at least one selected from the group consisting of calcium acetate, magnesium acetate, and a mixture of calcium acetate and magnesium acetate, but the present invention is not limited thereto.

The reaction in Step 2) is to fix the carbon dioxide dissolved in the contaminated water in the form of a carbonate mineral through biological metabolism of the rhodolith-derived microorganisms in the enrichment culture broth in Step 1) in the contaminated water. In this case, the reaction may be performed under an aerobic condition in which a sufficient amount of oxygen is supplied because the rhodolith-derived microorganism in the enrichment culture broth is an aerobic microorganism. That is, the rhodolith-derived microorganism in the enrichment culture broth forms a carbonate mineral by combining dissolved carbonate anions or hydrogen carbonate anions with calcium cations or magnesium cations through biological metabolism, and fix carbon dioxide dissolved in water in the form of a carbonate mineral. Further, the reaction may be carried out for 7 days at room temperature and under ambient pressure. The reaction enables fixing the carbon dioxide in the form of carbonate in a faster manner through complex interaction between various microorganisms included in the enrichment culture broth.

The carbonate mineral in Step 2) may be calcite, and components of the calcite are determined depending on the kind of metal cations existing in the contaminated water. That is, when the concentration of calcium cations in contaminated water is relatively high, carbon dioxide is fixed in the form of calcite having a higher portion of calcium carbonate, whereas, when the concentration of magnesium cations in the contaminated water is relatively high, carbon dioxide is fixed in the form of calcite having a higher portion of magnesium carbonate.

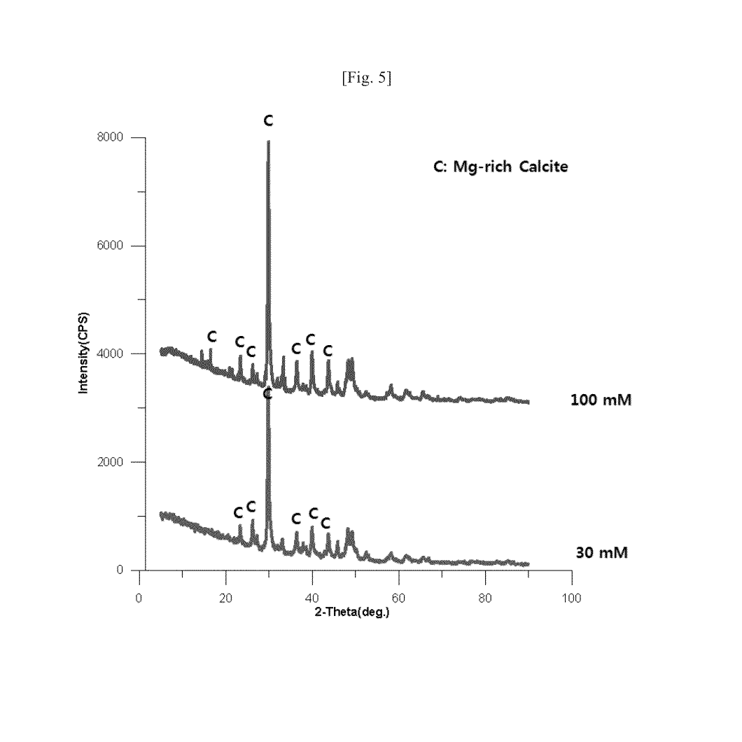

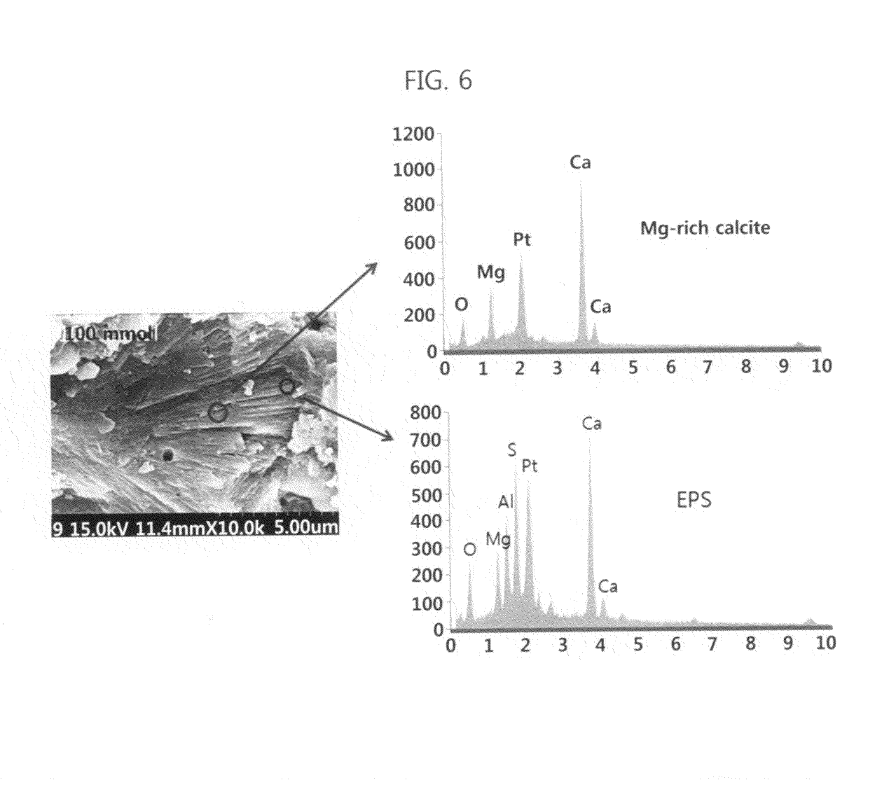

In the preferred embodiment of the present invention, 1.0 w/v % of the enrichment culture broth of the rhodolith-derived microorganism is added to the contaminated water along with 30 mmol or 100 mmol of the mixture of calcium acetate and magnesium acetate, and incubated for 7 days. As a result, in the experiment group to which 100 mmol of Ca/Mg-acetate was added, a white precipitate started to form first after 4 days with an increase in turbidity in an Erlenmeyer flask, and observed in all of the experiment groups after 7 days. Further, the XRD and XRF analyses of the precipitate show that CaO and MgO were measured to be present at contents of about 46% and about 5%, respectively, in the precipitate, which are similar to the XRF analyses of the rhodolith. Also, the XRD analyses show that a d(104) peak is measured to be 2.99 Å, which are similar to the XRD analyses of the rhodolith (see FIG. 5). In addition, the SEM-EDS analyses show that all of the precipitate is observed to be rhombohedron calcite, and that the higher the concentration of the mixture of calcium acetate and magnesium acetate is, increased surface size and roughness are observed (see FIG. 6).

2. Composition for Fixing Carbon Dioxide

Another aspect of the present invention provides a composition for fixing carbon dioxide dissolved in contaminated water, which includes an enrichment culture broth of microorganisms derived from rhodolith as an active ingredient to fix carbon dioxide dissolved in contaminated water in the form of a carbonate mineral.

The composition for fixing carbon dioxide dissolved in contaminated water according to the present invention includes an enrichment culture broth of rhodolith-derived microorganisms as an active ingredient.

The composition for fixing carbon dioxide dissolved in contaminated water is used in the method for fixing carbon dioxide described in detail in “1. Method for fixing carbon dioxide.” Thus, the description in “1. Method for fixing carbon dioxide” is quoted from the description of the method of using the composition herein, and only the other characteristics of the composition according to the present invention will be described.

The description of the rhodolith used for preparation of the composition is the same as described in detail in the section “1. Method for fixing carbon dioxide”. Accordingly, the rhodolith used for preparation of the composition also includes a carbonate mineral-forming microorganism, and the carbonate mineral-forming microorganism means all the various microorganisms which contribute to formation of carbonate mineral inhabiting rhodolith, including Proteus mirabilis and Marinobacterium coralli, which combines carbon dioxide or carbonate ions dissolved in water with metal cations during a metabolic pathway to form a carbonate mineral.

The enrichment culture broth may be prepared by the enrichment incubation of the rhodolith-derived microorganisms, which is described in detail in the section “1. Method for fixing carbon dioxide”, and more preferably, by the enrichment incubation including Steps (1′) and (2′). The enrichment culture broth includes at least one microorganism selected from the group consisting of Vibrio alginolyticus, Vibrio owensii, Vibrio xuii, Vibrio vulnificus, Vibrio fluvialis, Vibrio nereis, Proteus mirabilis, Marinobacterium coralli, Vagococcus fluvialis, Fusobacterium perfoetens, Tindallia californiensis, Arcobacter marinus, Parabacteroides gordonii, and Prolixibacter bellariivorans, but the present invention is not limited thereto. In the specific embodiment of the present invention, the 16S rRNA-DGGE analysis is performed to confirm the diversity of iron-reducing microorganisms existing in the enrichment culture broth of the rhodolith-derived microorganisms. As a result, various species of microorganisms, including Proteus mirabilis and Marinobacterium coralli are confirmed (see FIG. 4).

The composition may further include calcium cations or magnesium cations in the enrichment culture broth of the rhodolith-derived microorganisms. In particular, when the concentration of calcium cations or magnesium cations in the contaminated water is low, carbonate anions or hydrogen carbonate anions in the contaminated water may be easily fixed as a carbonate mineral. Thus, the calcium cations or magnesium cations are supplied to facilitate such fixation. Therefore, this may be attained by adding calcium salt or magnesium salt to the composition. The addition of calcium salt or magnesium salt may be performed by treatment of at least one selected from the group consisting of calcium acetate, magnesium acetate, and a mixture of calcium acetate and magnesium acetate, but the present invention is not limited thereto. In this case, any materials may be used without limitation as long as they can provide calcium cations or magnesium cations.

The contaminated water refers to water in which an excessive amount of carbon dioxide gas generated from artificial industrial activities is dissolved, that is, sea water or fresh water in which carbon dioxide to be fixed is dissolved. The carbon dioxide to be fixed may exist in the form of carbonate anions (CO₃²⁻) or hydrogen carbonate anions (HCO₃⁻) in the sea water or fresh water. In addition to the carbon dioxide, metal cations may exist in the contaminated water. The metal can be Group 1 or Group 2 metals, preferably Group 2 metals, and most preferably calcium or magnesium, but the present invention is not limited thereto. The carbonate anions or hydrogen carbonate anions are combined with calcium or magnesium cations existing in the contaminated water so that the carbonate anions or hydrogen carbonate anions are fixed in the form of a carbonate mineral. As a result, in the present invention, the combination of the cations and the anions may be facilitated by biological metabolism of the rhodolith-derived microorganisms. The various microorganisms in the enrichment culture broth included in the composition may facilitate the combination of the anions and the cations more effectively through complex interactions.

When the composition is treated in the contaminated water, the rhodolith-derived microorganisms in the enrichment culture broth included in the composition fixes carbon dioxide dissolved in the contaminated water in the form of a carbonate mineral through biological metabolism. Here, the carbonate mineral may be calcite. Components of the calcite are determined depending on the kind of metal cations existing in the contaminated water. That is, when the concentration of calcium cations in the contaminated water is relatively high, carbon dioxide is fixed in the form of calcite having a higher portion of calcium carbonate, whereas, when the concentration of magnesium cations in the contaminated water is relatively high, carbon dioxide is fixed in the form of calcite having a higher portion of magnesium carbonate.

In the preferred embodiment of the present invention, 1.0 w/v % of the enrichment culture broth of the rhodolith-derive microorganism is added to the contaminated water along with 30 mmol or 100 mmol of the mixture of calcium acetate and magnesium acetate, and incubated for 7 days. As a result, in the experiment group to which 100 mmol of the mixture of calcium acetate and magnesium acetate was added, a white precipitate started to form first after 4 days with an increase in turbidity in an Erlenmeyer flask, and observed in all of the experiment groups after 7 days. Further, the XRD and XRF analysis results of the precipitate show that CaO and MgO were measured to be present at contents of about 46% and about 5%, respectively, in the precipitate, which are similar to the XRF analysis results of the rhodolith. Also, the XRD analysis results show that a d(104) peak is measured to be 2.99 Å, which are similar to the XRD analysis results of the rhodolith (see FIG. 5). In addition, the SEM-EDS analysis results show that all of the precipitate is observed to be rhombohedron calcite, and that the higher the concentration of the mixture of calcium acetate and magnesium acetate is, increased surface size and roughness are observed (see FIG. 6).

The present invention will be described in detail with reference to the following examples. However, it should be understood that the description proposed herein is merely a preferable example for the purpose of illustration only, not intended to limit the scope of the invention.

### EXAMPLES

### Example 1

### Collection and Analysis of Rhodolith

<1-1> Analysis of Characteristics of Sea Water Around Udo

In order to determine chemical properties of the sea water from the beaches around Udo, Jeju Island, pH was measured, and inductively coupled plasma-atomic emission spectrometry (ICP-AES) analysis was performed. About 50 ml of a sea water sample was collected and pH of the sea water was then measured using an Orion pH meter. The pH meter was calibrated using solutions of pH 4, 7 and 10, and used to determine pH of the sea water. To determine the amount of cations existing in the sea water, a sea water sample was collected, and 1 ml of nitric acid was added to the sea water sample to prevent formation of a precipitate. Thereafter, the measurement was entrusted to the Seoul branch of the Korea Basic Science Institute.

As a result, pH of the sea water around Udo, Jeju Island was measured to be slightly acidic to neutral at about 5 to 8 on average (Table 2). From the ICP-AES analysis results, the concentration of calcium ions (Ca²⁺) was measured to be about 400 mg/l in the sea water around Udo, Jeju Island (Table 3).

Considering that calcite (CaCO₃), which is a carbonate mineral, is chemically formed at room temperature under basic conditions (pH=9.3 to 9.8) with a high saturation index (Saturation Index=1 to 1.4; the term “saturation index” means a concentration in which the concentration of Ca and CO₃²⁻ is high enough to chemically precipitate CaCO₃), it can be seen that the rhodolith found at the beach of Western Seogwang-ri in Udo, Jeju Island was formed by other reasons rather than by chemical reaction.

TABLE 2
pH measurement results of the sea water around Udo, Jeju Island

| Location | pH |
|---|---|
| Geolbeolrae beach (Eastern) | 7 |
| Seogwang-ri beach (Western) | 8 |
| Dolkani beach (Southern) | 7 |
| Hagosudong beach (Northern) | 5 |

TABLE 3
ICP-AES measurement results for the sea water around Udo, Jeju Island

Unit: mg/l

| | Geolbeolrae beach | Seogwang-ri beach | Hagosudong beach |
|---|---|---|---|
| Atom | (Eastern) | (Western) | (Northern) |
| Si | <0.01 | 0.34 | <0.01 |
| Sr | 6.25 | 6.25 | 6.31 |
| Ca | 406.7 | 396.1 | 405.8 |
| Mg | 1,264 | 1,225 | 1,239 |
| K | 393.2 | 380.3 | 378.7 |
| Na | 10340 | 10240 | 10270 |
| S | 877.5 | 873.6 | 910.7 |
| Cl | 21550 | 19540 | 19970 |

<1-2> Collection of Rhodolith

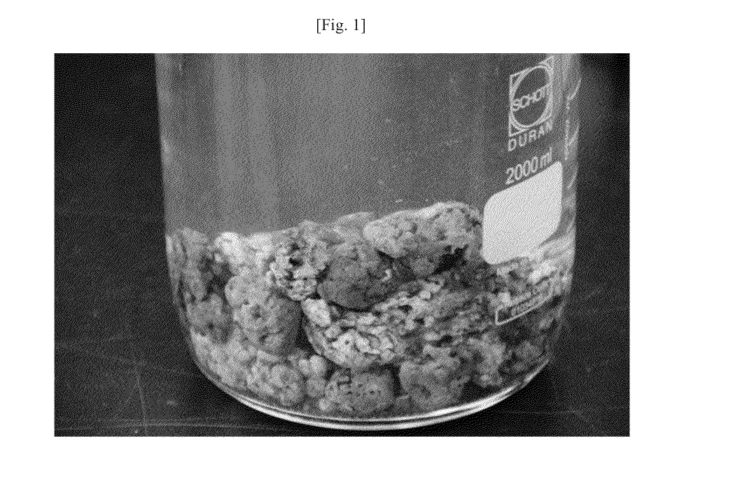

Rhodolith having a size of 5 cm to 7 cm existing in the sea water around the beach of Eastern Seogwang-ri, Udo, Jeju Island, was directly collected by hand during ebb tide (FIG. 1).

<1-3> Analysis of Geochemical and Mineralogical Properties of Rhodolith

To determine the geochemical and mineralogical properties of the rhodolith collected in Example 1-2, the XRF (X-Ray Fluorescence) and XRD (X-Ray Diffraction) analyses were performed. For the XRF and XRD analyses of the rhodolith, the rhodolith was pulverized, and the XRF analysis was then entrusted to the Seoul branch of the Korea Basic Science Institute. The analytic machine used for the XRD analysis of the pulverized rhodolith was an X′Pert PRO Multi Purpose X-Ray diffractometer using Cu—Kα rays and a Ni-filter. The analyses were performed under the conditions of an acceleration voltage of 40 kV, a current of 30 mA, a scan speed of 0.13°/sec, and a step size of 0.026° 2Th.

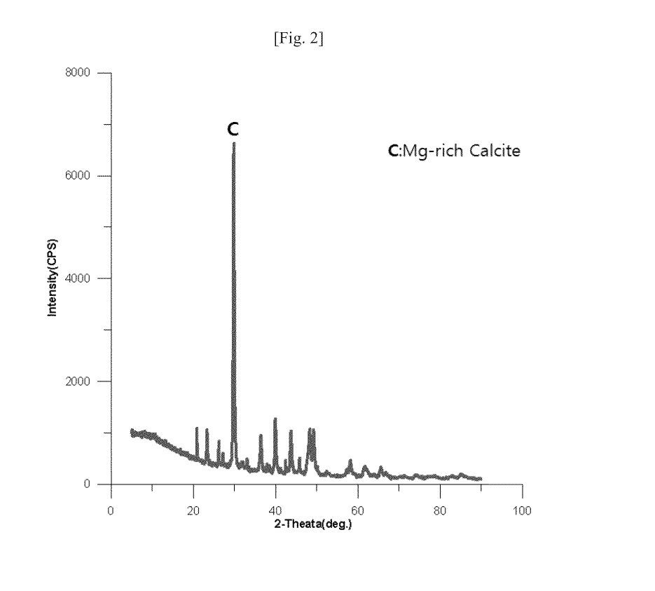

The XRF analysis results of the rhodolith showed that CaO and MgO were present at contents of about 46% and about 5%, respectively, and the XRD results showed that a d(104) peak value was 2.99 Å (FIG. 2).

From the results as described above, it was seen that the rhodolith was Mg-rich calcite having a calcite crystal structure in which most of the Ca was replaced with Mg having a small radius of gyration so that the Ca:Mg ratio reached 9:1. As described above, the rhodolith was composed of Mg-rich calcite (CaCO₃). This was because the Ca component was replaced with an Mg component having a small radius of gyration, a relatively larger amount of which was contained in the sea water around the Seogwang-ri beach, during formation of the calcite.

### Example 2

### Enrichment Incubation and Analysis of Carbonate-Forming Microorganism Derived from Rhodolith

<2-1> Enrichment Incubation of Carbonate-Forming Microorganism

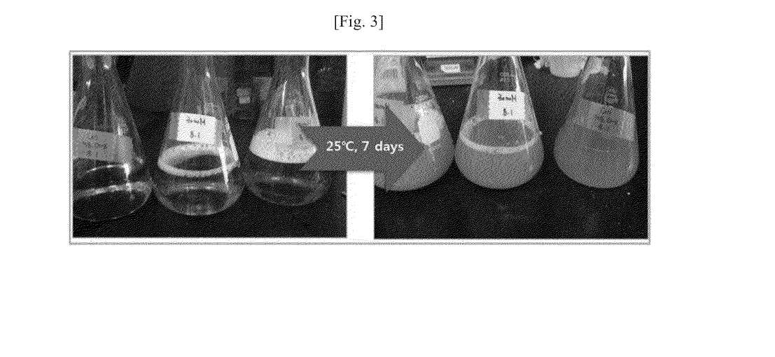

The rhodolith collected in Example 1-2 was pulverized using an agate and mortar. 5 g of the pulverized rhodolith was put into a 500 ml Erlenmeyer flask containing 100 ml of a D-1 medium having the compositions listed in Table 1, the entrance of the flask was sealed with a sponge in which oxygen and carbon dioxide can flow. Then, the rhodolith was incubated for 7 days at room temperature under ambient pressure with exposure to sunlight. Accordingly, the carbonate-forming microorganism was enrichment-incubated (FIG. 3). The D-1 medium used for the enrichment incubation of the carbonate-forming microorganism was sterilized at 121° C. for 20 minutes under high pressure for use.

<2-2> Analysis of Enrichment Culture Broth of Carbonate-Forming Microorganism Derived from Rhodolith

To determine the diversity of iron-reducing microorganisms existing in the enrichment culture broth of the rhodolith-derived, carbonate-forming microorganism enrichment-incubated in Example 2-1, the nucleic acid was extracted from the enrichment-incubated microorganism, and the 16S rRNA analysis was then performed using PCR. 20 μl of a reaction mixture including universal primers (a 9F primer (5′-GAG TTT GAT CCT GGC TCA G-3′), and a 1542R primer (5′-AGA AAG GAG GTG ATC CAG CC-3′), 0.1 μl of Taq polymerase (5 unit/μ1, TAKARA), 2 μl of a 10×PCR buffer and 1.6 μl of dNTP was prepared, and a fraction of 16S rRNA of the bacteria was amplified through PCR using 1 μl of the nucleic acid extracted from the microorganism as a template. The PCR-amplified product was subjected to 1% agarose gel electrophrosis, stained with ethidium bromide (EtBr), and the presence of the PCR product was then confirmed. The PCR product was re-amplified with primers having a GC clamp, and subjected to denaturing gradient gel electrophoresis (DGGE). The band on the DGGE gel was extracted, and sequenced.

As a result, a total of 234 microorganisms, including Vibrio alginolyticus, Vibrio owensii, Vibrio xuii, Vibrio vulnificus, Vibrio fluvialis, Vibrio nereis, Vagococcus fluvialis, Fusobacterium perfoetens, Tindallia californiensis, Arcobacter marinus, Parabacteroides gordonii, and Prolixibacter bellariivorans in addition to Proteus mirabilis and Marinobacterium coralli, were confirmed (FIG. 4).

The above-described microorganisms were expected to at least partly contribute to the formation of rhodolith. That is, rhodolith was considered to be formed by the mechanism in which carbon dioxide dissolved in water was fixed by being combined with metal cations in water, and formed as a carbonate mineral through the metabolism of the microorganisms, especially carbonate-forming microorganisms. Moreover, during such formation of the carbonate mineral, the various microorganisms were considered to fix carbon dioxide in the form of carbonate at a faster speed through complex interactions.

### Example 3

### Fixing Carbon Dioxide Dissolved in Water and Synthesis of Carbonate Mineral

<3-1> Fixing Carbon Dioxide Dissolved in Water and Synthesis of Carbonate Mineral

To a 500 ml Erlenmeyer flask containing 100 ml of an autoclaved D-1 medium having the compositions listed in Table 1, the enrichment-incubated culture broth (hereinafter referred to as an “enrichment culture broth”) prepared in Example 2-1 was inoculated at a concentration of 1w/v %, based on the volume of the medium, a mixture of calcium acetate and magnesium acetate was added thereto, and the entrance of Erlenmeyer flask was then sealed with a sponge in which oxygen and carbon dioxide can flow. Then, the rhodolith was incubated for 7 days under experimental conditions of room temperature and ambient pressure with exposure to sunlight. Here, the experiment was performed with three divided experiment groups (0 mmol, 30 mmol and 100 mmol) according to the concentration of the added mixture of calcium acetate and magnesium acetate. That is, the experiment was performed under the condition in which the mixture of calcium acetate and magnesium acetate in the medium and carbon dioxide existing in the atmosphere could react with carbonate anions or hydrogen carbonate anions dissolved in the medium to form a carbonate mineral.

As a result, for the experiment group to which 100 mmol of the mixture of calcium acetate and magnesium acetate was added, a white precipitate started to form first after 4 days with an increase in turbidity in the Erlenmeyer flask, and observed in all of the experiment groups after 7 days.

<3-2> Analysis of Geochemical and Mineralogical Properties of Resulting Precipitate

To analyze the geochemical and mineralogical properties of the precipitate prepared in Example 3-1, XRD, XRF and SEM-EDS analyses were performed. For such analyses, the resulting precipitate was first separated using a centrifuge, and a pellet of the precipitate was then dried at room temperature, and subjected to XRD, XRF and SEM-EDS.

The XRD and XRF analysis results of the resulting precipitates from the three experiment groups showed that CaO and MgO were present at contents of about 46% and about 5%, respectively, in the precipitate, which were similar to the XRF analysis results of the rhodolith. Also, the XRD analysis results showed that a d(104) peak was measured to be 2.99 Å, which were similar to the XRD analysis results of the rhodolith (see FIG. 5). That is, it could be seen that the resulting precipitate produced in Example 3-1 was Mg-rich calcite having a calcite crystal structure in which most of the Ca was replaced with Mg having a small radius of gyration so that the Ca:Mg ratio reached 9:1. In addition, the SEM-EDS analysis results showed that all of the resulting precipitates were observed to be rhombohedron calcite, and that the higher the concentration of the mixture of calcium acetate and magnesium acetate was, increased surface size and roughness were observed (see FIG. 6).

From the results as described above, it could be seen that the resulting precipitates prepared in Example 3-1 had the same components as the rhodolith collected in Example 1-2, and also that carbon dioxide dissolved in water could be fixed as a carbonate mineral in the enrichment culture broth in Example 2-1 using the principle in which a rhodolith-derived microorganism metabolized the carbon dioxide to form rhodolith.

The method for biologically fixing carbon dioxide according to the present invention has a simple fixing process and is environmentally friendly, compared with chemical carbon dioxide fixing technology. In addition, this method enables fast fixation of carbon dioxide even at room temperature, and thus can be easily applied in the industrial field, and is also useful in an aspect of resource recycling since the carbon dioxide is eventually fixed in the form of calcium carbonate.

However, the advantages of the present invention are limited to the effects as mentioned above, but other advantages which are not mentioned herein would be clearly understood from the following description, as apparent to those skilled in the art.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A method for fixing carbon dioxide dissolved in contaminated water, comprising:
enrichment-incubating a microorganism derived from rhodolith; and
treating the enrichment-cultured microorganism in contaminated water, and reacting the enrichment-cultured microorganism under an aerobic condition;
wherein the carbon dioxide dissolved in the contaminated water is fixed as a carbonate mineral.

2. The method according to claim 1, wherein the enrichment-incubating of the microorganism comprises:
collecting rhodolith; and
putting the collected rhodolith into one medium selected from the group consisting of a D-1 medium, an MH medium and a saline medium, each of which contains calcium salt or magnesium salt, and incubating the rhodolith under an aerobic condition.

3. The method according to claim 1, wherein the enrichment-cultured microorganism is treated in a concentration of 0.5 w/v % to 1.5 w/v % of a total volume of the contaminated water.

4. The method according to claim 1, further treating the contaminated water with calcium salt or magnesium salt.

5. The method according to claim 1, further treating the contaminated water with at least one selected from calcium acetate, magnesium acetate, and a mixture of calcium acetate and magnesium acetate.

6. The method according to claim 1, wherein the carbonate mineral is calcite.

7. A composition for fixing carbon dioxide dissolved in contaminated water, which comprises an enrichment culture broth of a microorganism derived from rhodolith as an active ingredient to fix carbon dioxide dissolved in contaminated water in the form of a carbonate mineral.

8. The composition according to claim 7, wherein the enrichment culture broth of the microorganism derived from rhodolith comprises at least one microorganism selected from the group consisting of Vibrio alginolyticus, Vibrio owensii, Vibrio xuii, Vibrio vulnificus, Vibrio fluvialis, Vibrio nereis, Proteus mirabilis, Marinobacterium coralli, Vagococcus fluvialis, Fusobacterium perfoetens, Tindallia californiensis, Arcobacter marinus, Parabacteroides gordonii, and Prolixibacter bellariivorans.

9. The composition according to claim 7, further comprising calcium salt or magnesium salt.

10. The composition according to claim 7, further comprising at least one selected from the group consisting of calcium acetate, magnesium acetate, and a mixture of calcium acetate and magnesium acetate.

11. The composition according to claim 7, wherein the carbonate mineral is calcite.
